(19) United States
(12) Patent Application Publication
(10) Pub. No.: US 2018/0026371 A1
(43) Pub. Date: Jan. 25, 2018

(54) MINIATURE WIDEBAND ANTENNA WITH PARASITIC ELEMENT

(71) Applicant: Arcadyan Technology Corporation, Hsinchu City (TW)

(72) Inventor: Jing-Teng Chang, Hsinchu City (TW)

(21) Appl. No.: 15/372,704

(22) Filed: Dec. 8, 2016

(30) Foreign Application Priority Data
Jul. 20, 2016 (TW) 105210930

(51) Int. Cl. H01Q 5/392; H01Q 1/48; H01Q 1/38; H01Q 1/22

(52) U.S. Cl. CPC H01Q 5/392; H01Q 1/2291; H01Q 1/48; H01Q 1/38

(57) ABSTRACT

A wideband antenna structure is disclosed. The wideband antenna is disposed on a printed circuit board, and includes a substrate, a first ground sheet, a main radiator and a parasitic element. The substrate has a first surface and a second surface opposite to the first surface. The first surface includes a first antenna area and a first grounding area connected to the first antenna area. The first antenna area has a first side along a first direction, a second side along a second direction, a third side opposite to the first side and a fourth side opposite to the second side. The first grounding sheet is disposed in the first grounding area, and next to the first, the second and the third sides. The main radiator is disposed in the first antenna area, and includes a feeding point near the second side; a first radiator extending from the feeding point along the first direction to a turning point; and a second radiator extending from the turning point toward the third side along the second direction. The parasitic element is disposed along the second direction. A first gap is formed between the parasitic element and the second radiator.

### CROSS-REFERENCE TO RELATED APPLICATION AND CLAIM OF PRIORITY

The application claims the benefit of Taiwan Patent Application No. 105210930, filed on Jul. 20, 2016, at the Taiwan Intellectual Property Office, the disclosures of which are incorporated herein in their entirety by reference.

### FIELD OF THE INVENTION

The present invention is related to a wideband antenna structure, and more particularly to a miniature wideband antenna disposed on a printed circuit board.

### BACKGROUND OF THE INVENTION

In the era of wireless communication, particularly when WiFi networks and wireless LAN are overwhelmingly popular, the 3C products require miniaturization and bandwidth for communication, and antennas in the electronic products have to be more compact while having the function of wideband communication. Among the commonly used frequency bands for WiFi communication, such as the two main bands 2.4 GHz and 5 GHz which comply with the IEEE802.11 standard, disturbance to the 2.4 GHz band is larger than the others, because it is widely applied to such as microwave ovens and Bluetooth communication which will interfere with WiFi signals. On the contrary, disturbance to the 5 GHz band is much smaller.

To realize the specification with a main frequency band at 5 GHz, the frequency range for transmission of an antenna has to be sufficiently wide. Traditional monopole antennas can be designed according to the specific frequency or wavelength of the main frequency band, but cannot support sufficient frequency bandwidth. In addition, for the purpose of good appearance and convenience of assembly, the antennas have to be compact so as to be disposed inside the elements of electronic products, i.e., miniature design for the antennas.

In order to overcome the drawbacks in the prior art and achieve the design purpose of a miniature wideband antenna, a new antenna structure is required.

### SUMMARY OF THE INVENTION

In accordance with one aspect of the present invention, a wideband antenna structure is disclosed. The wideband antenna is disposed on a printed circuit board, and includes a substrate, a first grounding sheet, a main radiator and a parasitic element. The substrate has a first surface and a second surface opposite to the first surface. The first surface includes a first antenna area and a first grounding area connected to the first antenna area. The first antenna area has a first side along a first direction, a second side along a second direction, a third side opposite to the first side and a fourth side opposite to the second side. The first grounding sheet is disposed on the first grounding area, and next to the first, the second and the third sides. The main radiator is disposed on the first antenna area, and includes a feeding point near the second side; a first radiator extending from the feeding point along the first direction to a turning point; and a second radiator extended from the turning point toward the third side along the second direction. The parasitic element is disposed along the second direction. A first gap is formed between the parasitic element and the second radiator.

In accordance with another aspect of the present invention, a wideband antenna structure is disclosed. The wideband antenna is disposed on a printed circuit board, and includes a substrate, a grounding sheet, a main radiator and a parasitic element. The grounding sheet has a first inner side extending along a first direction, a second inner side connected to the first inner side and extending along a second direction and a third inner side connected to the second inner side and opposite to the first inner side. The first, the second and the third inner sides form an opening near an outer side of the substrate. The main radiator includes a feeding point near the second inner side; a first radiator extending from the feeding point along the first direction to a turning point; and a second radiator extended from the turning point toward the third inner side along the second direction. The parasitic element extends from the third inner side along the second direction toward the first inner side. A first gap is formed between the parasitic element and the second radiator.

In accordance with a further aspect of the present invention, a wideband antenna structure is disclosed. The wideband antenna is disposed on a substrate having a first surface and a second surface opposite to the first surface. The wideband antenna has a first grounding sheet, a main radiator and a parasitic element. The first grounding sheet is disposed on the first surface, and has a first inner side along a first direction, a second inner side connected to the first inner side and extending along a second direction and a third inner side connected to the second inner side and opposite to the first inner side. The first, the second and the third inner sides form an opening near an outer side of the substrate. The main radiator includes a feeding point near the second inner side; a first radiator extending from the feeding point along the first direction to a turning point; and a second radiator extending from the turning point toward the third inner side along the second direction. The parasitic element is disposed along the second direction. A first gap is formed between the parasitic element and the second radiator.

The wideband antenna design in the present invention can fully satisfy the requirements in terms of being miniature and having suitable bandwidth, and can comprehensively realize the requirements for a main frequency band of 5 GHz according to the IEEE802.11 specification or even wider bandwidth. Thus, the present invention has utility for industry.

The objectives and advantages of the present invention will become more readily apparent to those ordinarily skilled in the art after reviewing the following detailed descriptions and accompanying drawings, in which:

### BRIEF DESCRIPTION OF THE DRAWINGS

FIG. 1A is a schematic diagram showing a substrate to be used to dispose a wideband antenna with a parasitic element thereon according to the present invention;

FIG. 1B is a schematic diagram showing a wideband antenna with a parasitic element according to one embodiment of the present invention;

FIG. 2 is a schematic diagram showing a wideband antenna with a parasitic element according to another embodiment of the present invention;

FIGS. 3A and 3B are a set of schematic diagrams showing a wideband antenna with a parasitic element according to another embodiment of the present invention, wherein FIG. 3A shows a front-view and FIG. 3B shows a back-view;

FIGS. 4A and 4B are a set of schematic diagrams showing a wideband antenna with a parasitic element according to yet another embodiment of the present invention, wherein FIG. 4A shows a front-view and FIG. 4B shows a back-view;

FIG. 5 is a schematic diagram showing an equivalent circuit of the wideband antenna according to the present invention; and

FIG. 6 is a graph showing the return losses of the antenna manufactured according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purposes of illustration and description only; they are not intended to be exhaustive or to be limited to the precise form disclosed.

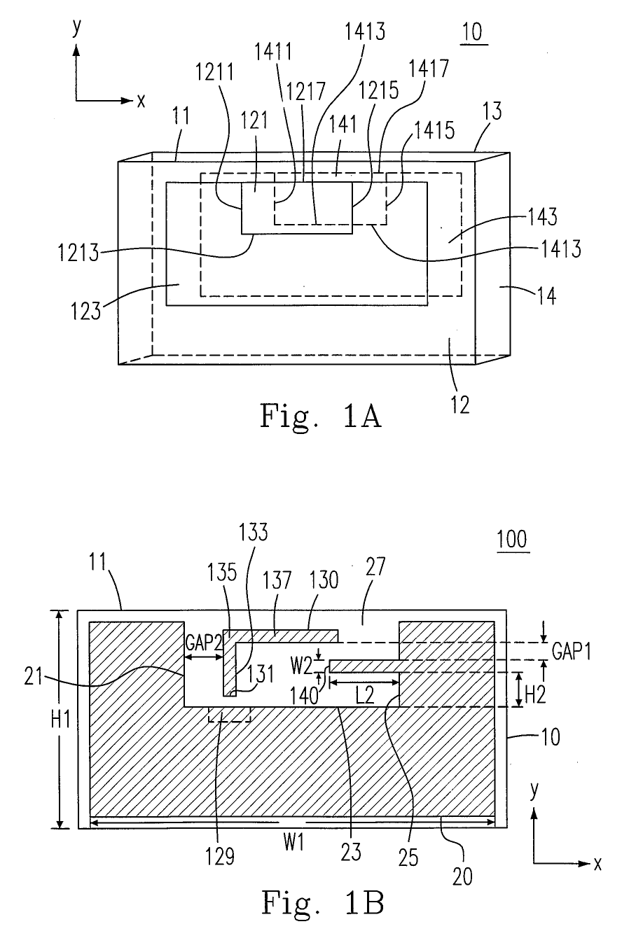

Please refer to FIG. 1A, which shows a substrate 10 to be used to dispose a wideband antenna with a parasitic element thereon according to the present invention. According to the design concept of the present invention, the substrate 10 can be configured to be a multi-layered printed circuit board (PCB), or simply a substrate formed of dielectric materials. According to FIG. 1, the substrate 10 has a first surface 12 and a second surface 14 opposite to the first surface 12. The first surface 12 and the second surface 14 have a first outer edge 11 and a second outer edge 13 respectively. As shown in FIG. 1A, a first direction Y and a second direction X perpendicular to the first direction Y, the first direction Y and the second direction X define a plane parallel to the first and the second surfaces 12, 14. From another point of view, it can be appreciated that the first surface 12 has the first direction Y and the second direction X. The same is also true for the second surface 14.

The first surface 12 includes a first antenna area 121 and a first grounding area 123 connected to the first antenna area 121. The first antenna area 121 has a first side 1211 along the first direction Y, a second side 1213 along a second direction X, a third side 1215 opposite to the first side 1211 and a fourth side 1217 opposite to the second side 1213. Likewise, the second surface 14 includes a second antenna area 141 and a second grounding area 143 connected to the second antenna area 141. The second antenna area 141 has a fifth side 1411 along the first direction Y, a sixth side 1413 along a second direction X, a seventh side 1415 opposite to the fifth side 1411 and an eight side 1417 opposite to the sixth side 1413.

Please refer to FIG. 1B, which shows a wideband antenna 100 according to one embodiment of the present invention. The wideband antenna 100 includes the substrate 10 as shown in FIG. 1A, a first grounding sheet 20 disposed on the first grounding area 123 and next to the first side 1211, the second side 1213 and the third side 1215 of the first antenna area 121, a main radiator 130 and a parasitic element 140. The main radiator 130 includes a feeding point 131 near the second side 1213, a first radiator 133 extending from the feeding point 131 along the first direction Y to a turning point 135; and a second radiator 137 extending from the turning point 135 toward the third side 1215 along the second direction X. The parasitic element 140 is connected to the first grounding sheet 20 and extends from the third side 1215 along (opposite to) the second direction X.

The main radiator 130 has a first total length L1, the parasitic element 140 has a second total length L2, and the first total length L1 is larger than the second total length L2. Both the parasitic element 140 and the second radiator 137 are disposed along the second direction X, and it can be observed that a first gap GAP 1 is formed therebetween. The first gap GAP 1 between the parasitic element 140 and the second radiator 137 can generate an electric coupling effect. If the second radiator 137 carries a current, such a current can be transmitted to the parasitic element 140 through electric coupling. In FIG. 1B, it can be observed that the parasitic element 140 and the second radiator 137 are partially overlapping to each other when viewed along the first direction Y. However, according to another embodiment of the present invention, electric coupling can occur through the first gap GAP1 even though there is no overlap between the parasitic element 140 and the second radiator 137 when viewing along the first direction Y. The skilled person in the art can appreciate that, based on the flow direction of the electric current (not shown), the electric coupling between the parasitic element 140 and the second radiator 137 causes capacity coupling.

The first total length L1 of the main radiator 130 can affect the antenna's main resonant frequency, which has a corresponding wavelength (hereinafter, denoted as λ). In general, the first total length L1 can be designed to a quarter of the corresponding wave length λ. For example, the first total length L1 can be about 54.5 millimeters, which is a quarter of the wavelength corresponding to the frequency of 5.5 GHz.

Again in FIG. 1B, the first grounding sheet 20 has a first width W1 and a first height H1, wherein the first width W1 is longer than or equal to 0.29λ, and the first height H1 ranges between 0.18λ and 0.5λ. The parasitic element 140 has a second length L2 and a second width W2, wherein the second length L2 ranges between 0.18λ to 0.25λ, and W2 is larger than 0.001λ. The first gap GAP 1 ranges between 0.007λ and 0.163λ.

Referring to FIGS. 1A and 1B simultaneously, the first grounding sheet 20 includes a first inner side 21 extending along the first direction Y, a second inner side 23 connected to the first inner side 21 and extending along the second direction X and a third inner side 25 connected to the second inner side 23 and opposite to the first inner side 21, wherein the first, the second and the third inner sides 21, 23, 25 all together form a first opening 27 near the first outer side 11 of the substrate 10. The first, the second and the third inner sides 21, 23, 25 of the first grounding sheet 20 are disposed next to the first, the second and the third sides 1211, 1213, 1215 of the first antenna area 121 respectively. Thus, the feeding point 131 of the main radiator is near the second inner side 23 of the first grounding sheet 20. The first radiator 133 extends from the feeding point 131 along the first direction Y to the turning point 135. The second radiator 137 extends from the turning point 135 toward the third inner side 25 along the second direction X. The parasitic element 140 extends from the third inner side 25 along the second direction X toward the first inner side 21. The length of the second inner side 23 ranges from between 0.18λ and 0.26λ. The distance between the parasitic element 140 and the second inner side 23 defines a second height H2, which is larger than 0.001λ. A second gap GAP 2 is formed between the first radiator 133 and the first inner side 21, and ranges from between 0.007λ and 0.163λ. In some embodiments of the present invention, the existence of the second gap GAP 2 contributes efficacy to the electric coupling. The area at the second inner side 23 of the grounding sheet 20 near the feeding point 131 can be used to dispose a grounding point 129 therein.

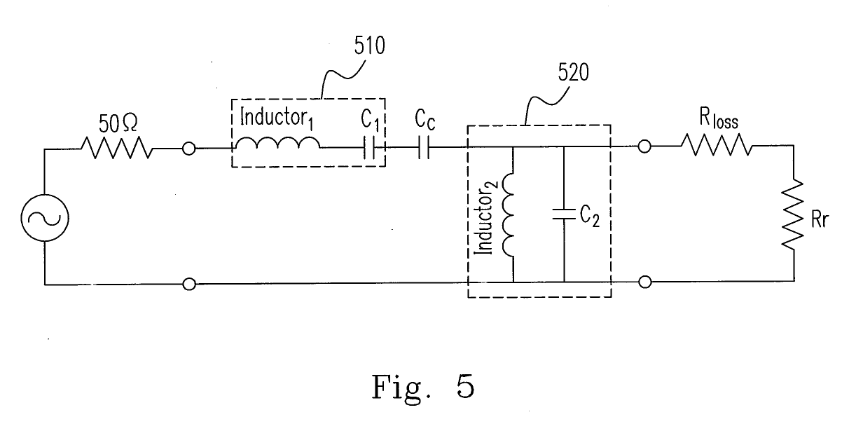

Please refer to FIG. 5, which is a schematic diagram showing an equivalent circuit of the wideband antenna according to the present invention. The skilled person in the art can understand that the area 510 including the first inductor Inductor 1 and the first capacitor C₁ corresponds to the electric effect generated by the main radiator 130, the area 520 including the second inductor Inductor 2 and the second capacitor C₁ corresponds to the electric effect generated by the parasitic element 140, and the capacity coupling C_{C} between the first area 510 and the second area 520 is due to the electric coupling between the first radiator 130 and the parasitic element 140. Rₗₒₛₛ and Rr denotes the resistance due to the antenna material's consumption and the radiation resistance of the wideband antenna respectively.

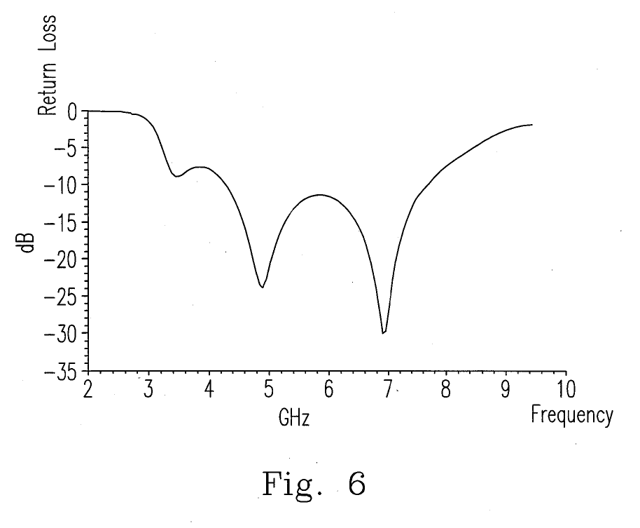

Please refer to FIG. 6, which shows the functional character of a wideband antenna manufactured according to the present invention. According to the illustration of FIG. 6, sufficient antenna efficacy occurs at the frequency region between 4.3 GHz and 7.7 GHz, wherein a significant antenna resonant effect can be observed at the frequencies of 5 Hz and 7 Hz. With reference to the antenna structure shown in FIG. 1B, the skilled person in the art can understand that the resonant frequency near 5 Hz is caused by the main radiator 130 while the other resonant frequency near 7 Hz is caused by the parasitic element 140 due to the effect of electric coupling. According to other embodiments of the present invention, the resonant frequency caused by the main radiator 130 will move toward the lower frequency direction on the condition that the second length L2 of the parasitic element 140 is adjusted to be longer, while the resonant frequency caused by the main radiator 130 remains close to 7 Hz. It can be observed that the antenna performance in terms of the return loss becomes even better, i.e., the longer the parasitic element 140, the wider the range of bandwidth of the wideband antenna 100.

As illustrated in FIG. 6, the efficacy of the wideband antenna according to the present invention fully complies with the specification of the communication bandwidth required in IEEE802.11a. In addition, the skilled person in the art can apply the same concept when designing wideband antenna with different main frequencies based on the present invention.

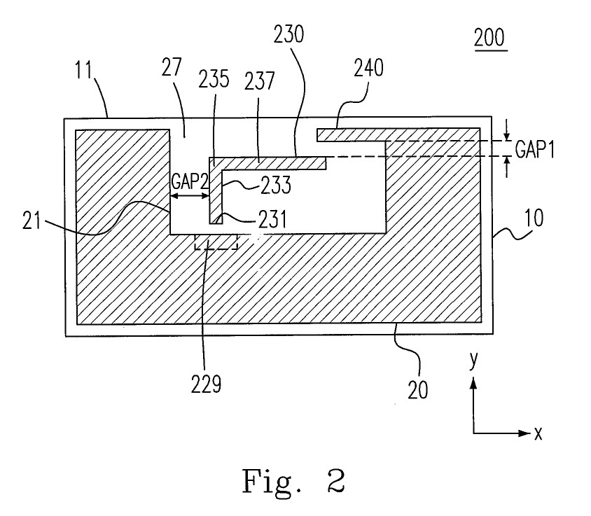

Based on the wideband antenna design according to present invention, one may adjust the relative positions of the main radiator 130 and the parasitic element 140 to obtain the same antenna efficacy as shown in FIG. 6, as long as there is the first gap GAP 2 between the main radiator 130 and the parasitic element 140. Please refer to FIG. 2, which shows a wideband antenna 200 with a parasitic element according to another embodiment of the present invention. In FIG. 2, the wideband antenna 200 includes the substrate 10 as shown in FIG. 1A, the first grounding sheet 20 as shown in FIG. 1B, a main radiator 230 and a parasitic element 240. The shape, the dimension and the location of the first grounding sheet 20 is introduced in the precedent descriptions so there is no need to repeat it here. Likewise, the main radiator 230 and the parasitic element 240 are disposed on the first antenna area 121 of the substrate 10.

Referring to FIG. 2, a feeding point 231 of the main radiator 230 is near the second inner side 23 of the first grounding sheet 20, a first radiator 233 extends from the feeding point 231 along the first direction Y to a turning point 235, a second radiator 237 extends from the turning point 235 toward the third inner side 25 along the second direction X, and the parasitic element 240 is connected to the first grounding sheet 20 and extends from the third inner side 25 along (opposite to) the second direction X. Likewise, the area at the second inner side 23 of the grounding sheet 20 near the feeding point 231 can be used to dispose a grounding point 229 therein. Being different from the embodiment illustrated in FIG. 1B, the parasitic element 240 in FIG. 2 is disposed at the location near the first outer side 11 of the substrate 11. In FIG. 2, it is illustrated that the first gap GAP 1 between the main radiator 230 and the parasitic element 240 is formed on top of the main radiator 230. The dimensions of the main radiator 230, the parasitic element 240 and the first gap GAP 1 in FIG. 2 are the same as those of the main radiator 130, the parasitic element 140 and the first gap GAP 1 in FIG. 1B respectively, and therefore there is no need to repeat it here.

According to the wideband antenna design of the present invention, the main radiator and the parasitic element can be respectively disposed on different surfaces of the substrate. For example, one of those can be disposed on the first surface 12 of the substrate 10 with the other on the second surface 14, as long as the relative positions of the two do not overlap and maintain the first gap GAP1 for electric coupling so as to realize the antenna efficacy as shown in FIG. 6.

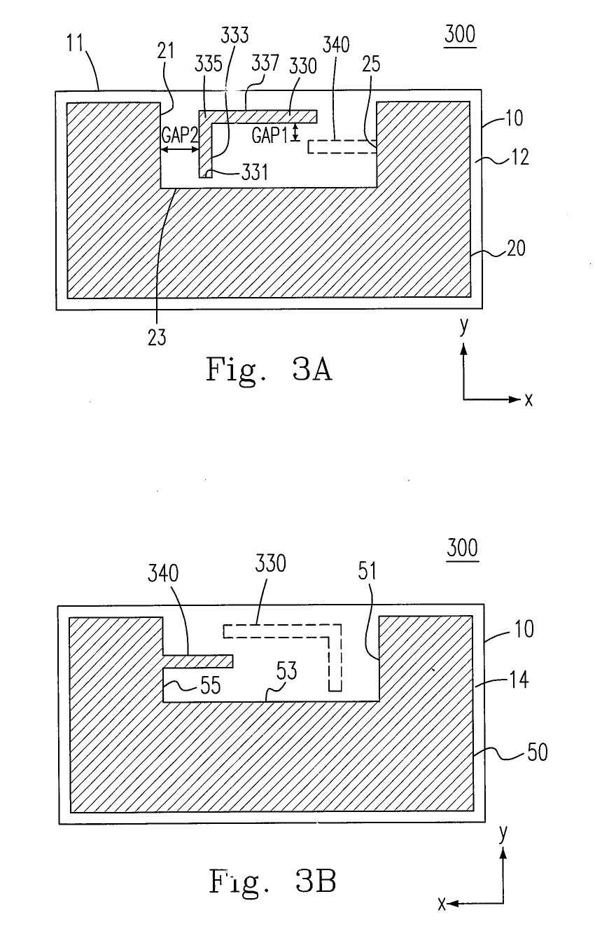

Please refer to FIGS. 3A and 3B, which jointly show a wideband antenna 300 with a parasitic element according to another embodiment of the present invention. In FIGS. 3A and 3B, the wideband antenna 300 includes the substrate 10 as shown in FIG. 1A, a first grounding sheet 20, a main radiator 330, a parasitic element 340 and a second grounding sheet 50. The first grounding sheet 20 and the main radiator 330 are disposed on the first surface 12 of the substrate 10, and the second grounding sheet 50 and the parasitic element 340 on the second surface 14 of the substrate 10. The shape, the dimension and the location of the first grounding sheet 20 have been described in detail on the precedent descriptions, and therefore there is no need to repeat it here. The shape, the dimension and the location of the second grounding sheet 50 is exactly an image of the first grounding sheet 20 projected on the second surface 14, and therefore there is no need to repeat it here. It is observed that the main radiator 330 is located in the first antenna area 121 while the parasitic element 340 in the second antenna area 141.

The shape and the dimension of the second grounding sheet 50 on the second surface 14 correspond to those of the first grounding sheet 20. More specifically, the second grounding sheet 50 includes the fourth inner side 51 along the first direction Y, the fifth inner side 53 connecting to the fourth inner side 51 and along the second direction X and the sixth inner side 55 connecting to the fifth inner side 53 and opposite to the fourth inner side 51. The fourth inner side 51, the fifth inner side 53 and the sixth inner side 55 together form a second opening 57 near the second outer side 13 of the substrate 10. The first, the second and the third inner sides 51, 53, 55 of the second grounding sheet 50 are disposed next to the fifth, the sixth and the seventh sides 1411, 1413, 1415 of the second antenna area 141 respectively.

Similarly, the feeding point 331 of the main radiator 330 is near the second inner side 23 of the first grounding sheet 20, the first radiator 333 extends from the feeding point 331 along the first direction Y to the turning point 335, the second radiator 337 extends from the turning point 335 toward the third inner side 25 along the second direction X, and the parasitic element 340 extends from the sixth inner side 55 corresponding to the third inner side 25 along the second direction X toward the fourth inner side 51. The dimensions of the main radiator 330, the parasitic element 340 and the first gap GAP 1 in FIGS. 3A and 3B are the same as those of the main radiator 130, the parasitic element 140 and the first gap GAP 1 respectively, and therefore there is no need to repeat it here.

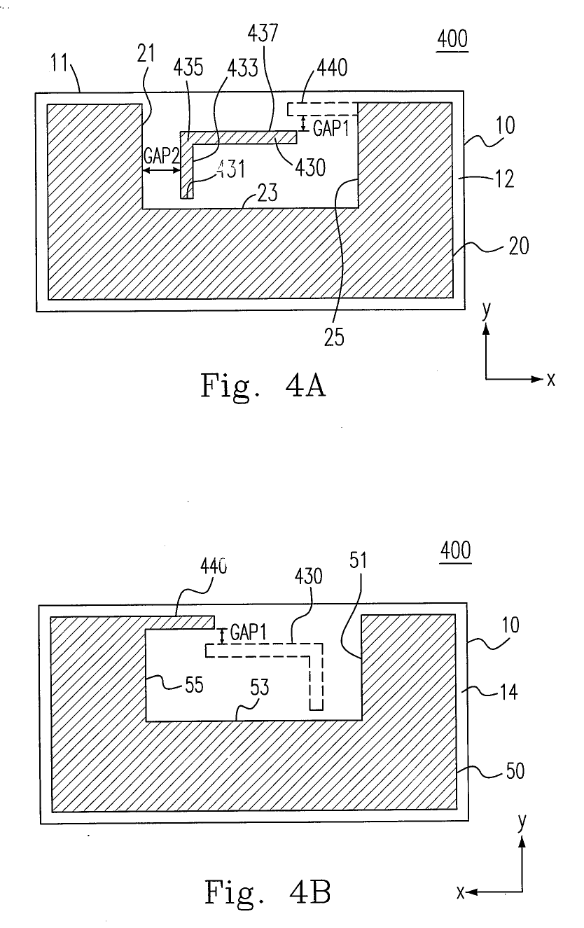

Please refer to FIGS. 4A and 4B, which jointly show a wideband antenna 400 with a parasitic element according to another embodiment corresponding to the one illustrated in FIG. 2. The wideband antenna 300 includes the substrate 10 as shown in FIG. 1A, a first grounding sheet 20, a main radiator 430, a parasitic element 440 and a second grounding sheet 50. The first grounding sheet 20 and the main radiator 430 are disposed on the first surface 12 of the substrate 10, with the second grounding sheet 50 and the parasitic element 440 on the second surface 14 of the substrate 10. The shape, the dimension and the location of the first grounding sheet 20 and the second ground sheet 50 have been described in detail on the precedent descriptions, and therefore there is no need to repeat it here. It can be observed that the main radiator 430 is located in the first antenna area 121 with the parasitic element 440 in the second antenna area 141. The dimensions of the main radiator 430, the parasitic element 440 and the first gap GAP 1 in FIGS. 4A and 4B are the same as those of the main radiator 230, the parasitic element 240 and the first gap GAP 1 respectively in FIG. 2, and therefore there is no need to repeat it here.

Based on the above, although those embodiments in FIGS. 1B, 2, 3A/3B and 4A/4B provide applicable alternatives for different ways of disposition, all these antenna structures have the same efficacy. For the reason the wideband antennas of the present invention have parasitic elements, which can generate a higher second resonant frequency through electric coupling, and therefore the frequency bandwidth can be expanded to enhance the antenna efficacy.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. A wideband antenna disposed on a printed circuit board, comprising:
a substrate having a first surface and a second surface opposite to the first surface, wherein the first surface includes a first antenna area and a first grounding area connected to the first antenna area, the first antenna area has a first side along a first direction, a second side along a second direction, a third side opposite to the first side and a fourth side opposite to the second side;
a first grounding sheet disposed on the first grounding area, and next to the first, the second and the third sides;
a main radiator disposed on the first antenna area, and including:
a feeding point near the second side;
a first radiator extending from the feeding point along the first direction to a turning point; and
a second radiator extended from the turning point toward the third side along the second direction; and
a parasitic element disposed along the second direction, wherein a first gap is formed between the parasitic element and the second radiator.

2. The wideband antenna as claimed in claim 1, wherein the second direction is perpendicular to the first direction.

3. The wideband antenna as claimed in claim 1, wherein the parasitic element is disposed on the first surface.

4. The wideband antenna as claimed in claim 3, wherein the parasitic element is disposed in the first antenna area.

5. The wideband antenna as claimed in claim 1, wherein the parasitic element is disposed on the second surface.

6. The wideband antenna as claimed in claim 5, wherein the second surface further include a second antenna area and a second grounding area corresponding to the first antenna and the first grounding area respectively, the wideband antenna further comprises a second grounding sheet disposed on the second grounding area, and the parasitic element is disposed on the second antenna area and connected to the second grounding sheet.

7. The wideband antenna as claimed in claim 1, wherein a second gap is formed between the first radiator and the first side.

8. The wideband antenna as claimed in claim 1, wherein the main radiator has a first total length, the parasitic element has a second total length, and the first total length is larger than the second total length.

9. A wideband antenna disposed on a substrate, comprising:
a grounding sheet having a first inner side extending along a first direction, a second inner side connected to the first inner side and extending along a second direction and a third inner side connected to the second inner side and opposite to the first inner side, wherein the first, the second and the third inner sides form an opening near an outer side of the substrate;
a main radiator including:
a feeding point near the second inner side;
a first radiator extending from the feeding point along the first direction to a turning point; and
a second radiator extending from the turning point toward the third inner side along the second direction; and
a parasitic element extending from the third inner side along the second direction toward the first inner side, wherein a first gap is formed between the parasitic element and the second radiator.

10. The wideband antenna as claimed in claim 9, wherein the second direction is perpendicular to the first direction.

11. The wideband antenna as claimed in claim 9, wherein a second gap is formed between the first radiator and the first side.

12. The wideband antenna as claimed in claim 9, wherein the main radiator has a first total length, the parasitic element has a second total length, and the first total length is larger than the second total length.

13. A wideband antenna disposed on a substrate having a first surface and a second surface opposite to the first surface, comprising:
a first grounding sheet disposed on the first surface, and having a first inner side along a first direction, a second inner side connected to the first inner side and extending along a second direction and a third inner side connected to the second inner side and opposite to the first inner side, wherein the first, the second and the third inner sides form an opening near an outer side of the substrate;
a main radiator including:
a feeding point near the second inner side;
a first radiator extending from the feeding point along the first direction to a turning point; and
a second radiator extended from the turning point toward the third inner side along the second direction; and
a parasitic element disposed along the second direction, wherein a first gap is formed between the parasitic element and the second radiator.

14. The wideband antenna as claimed in claim 13, wherein the second direction is perpendicular to the first direction.

15. The wideband antenna as claimed in claim 13, wherein the parasitic element is disposed on the first surface.

16. The wideband antenna as claimed in claim 15, wherein the parasitic element is extended to the third inner side and connected to the first grounding sheet.

17. The wideband antenna as claimed in claim 13, wherein the parasitic element is disposed on the second surface.

18. The wideband antenna as claimed in claim 17, wherein the wideband antenna further comprises a second grounding sheet disposed on the second surface, the second grounding sheet has a shape and a location corresponding to those of the first grounding sheet, and the parasitic element is connected to the second grounding sheet.

19. The wideband antenna as claimed in claim 13, wherein a second gap is formed between the first radiator and the first inner side.

20. The wideband antenna as claimed in claim 13, wherein the main radiator has a first total length, the parasitic element has a second total length, and the first total length is larger than the second total length.
